(19) United States
(12) Patent Application Publication
(10) Pub. No.: US 2026/0270372 A1
(43) Pub. Date: Sep. 10, 2026

(54) INFORMATION PROCESSING APPARATUS

(71) Applicant: NEC Corporation, Tokyo (JP)

(72) Inventor: Ryo SAKUMA, Tokyo (JP)

(73) Assignee: NEC Corporation, Tokyo (JP)

(21) Appl. No.: 19/535,481

(22) Filed: Feb. 10, 2026

(30) Foreign Application Priority Data
Mar. 6, 2025 (JP) 2025-035398

(51) Int. Cl. H04N 7/18; G06V 20/52

(52) U.S. Cl. CPC H04N 7/181; G06V 20/52

(57) ABSTRACT

An information processing apparatus includes an acquiring unit that acquires load information indicating a load corresponding to each of observation nodes that observes an object, and an allocation unit that, with use of the acquired load information, allocates observation nodes that perform observations subject to integration processing to a plurality of integration processing nodes that perform integration processing to integrate observation results by the observation nodes.

### INCORPORATION BY REFERENCE

The present invention is based upon and claims the benefit of priority from Japanese patent application No. 2025-035398, filed on Mar. 6, 2025, the disclosure of which is incorporated herein in its entirety by reference.

### TECHNICAL FIELD

The present invention relates to an information processing apparatus, an information processing method, and a storage medium.

### BACKGROUND ART

Techniques used to integrate a plurality of observation results acquired using a plurality of observation nodes such as security cameras are known.

As a related document, Patent Literature 1 is known. Patent Literature 1 describes a subarea monitoring device having an integration processing unit that integrates monitoring results obtained from a first subarea monitoring unit and a second subarea monitoring unit to generate a monitoring result for the entire subarea.

Patent Literature 1: JP 2019-153986 A

### SUMMARY

When there are a plurality of observation nodes, integration processing may be distributed to a plurality of devices. In this case, depending on how the observation nodes are divided, the load may be unevenly distributed among specific devices, making it difficult to perform efficient integration processing. As described above, in the case of performing integration processing distributed among a plurality of devices, there is a problem that it is sometimes difficult to achieve appropriate distribution.

Therefore, an example object of the present disclosure is to provide an information processing apparatus, an information processing method, and a program that can solve the aforementioned problem.

In order to achieve such an example object, an information processing apparatus according to the present disclosure is configured to include

an acquiring unit that acquires load information indicating a load corresponding to each of observation nodes that observes an object, and

an allocation unit that, with use of the acquired load information, allocates observation nodes that perform observations subject to integration processing to a plurality of integration processing nodes that perform integration processing to integrate observation results by the observation nodes.

Further, an information processing method according to the present disclosure is configured to include, by an information processing apparatus,

acquiring load information indicating a load corresponding to each of observation nodes that observes an object, and

with use of the acquired load information, allocating observation nodes that perform observations subject to integration processing to a plurality of integration processing nodes that perform integration processing to integrate observation results by the observation nodes.

Further, a storage medium according to the present disclosure is a computer-readable storage medium storing thereon a program for causing an information processing apparatus to execute processing to:

acquire load information indicating a load corresponding to each of observation nodes that observes an object; and

with use of the acquired load information, allocate observation nodes that perform observations subject to integration processing to a plurality of integration processing nodes that perform integration processing to integrate observation results by the observation nodes.

According to the above-described configurations, in the case of performing integration processing distributed among a plurality of devices, distribution can be performed more appropriately.

### BRIEF DESCRIPTION OF DRAWINGS

FIG. 1 illustrates an overview of integration processing;

FIG. 2 illustrates an example configuration of a data integration system;

FIG. 3 is a block diagram illustrating an example configuration of a control device;

FIG. 4 illustrates an example of positional relationship information;

FIG. 5 illustrates an example of load information;

FIG. 6 illustrates an example of processing time information;

FIG. 7 illustrates an example of weighting processing;

FIG. 8 illustrates an example of allocation processing;

FIG. 9 illustrates an example of allocation processing;

FIG. 10 illustrates an example of allocation processing;

FIG. 11 is a flowchart illustrating an example of operation during integration processing;

FIG. 12 is a flowchart illustrating a more detailed example of operation of allocation processing;

FIG. 13 is a block diagram illustrating an example configuration of a control device;

FIG. 14 is a block diagram illustrating an example of a hardware configuration of an information processing apparatus;

FIG. 15 is a block diagram illustrating an example configuration of an information processing apparatus; and

FIG. 16 is a flowchart illustrating an example of operation of the information processing apparatus.

### EXAMPLE EMBODIMENTS

### First Example Embodiment

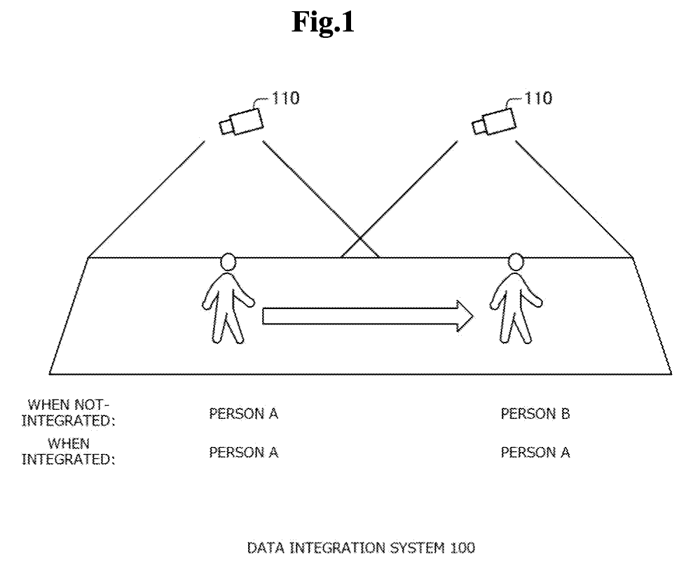

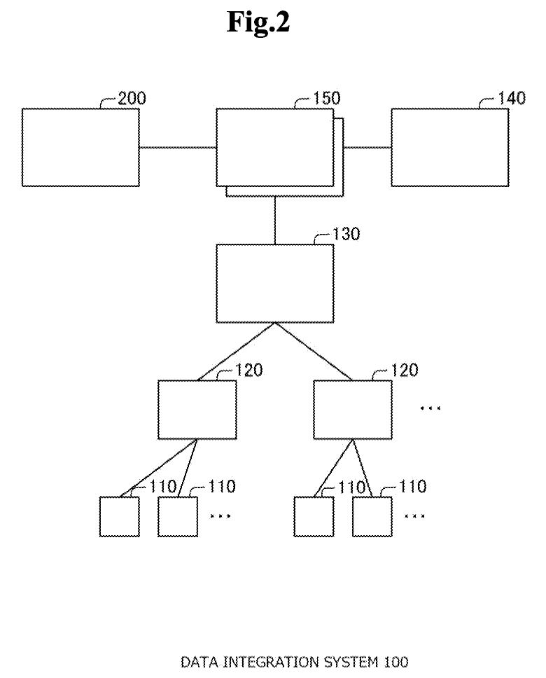

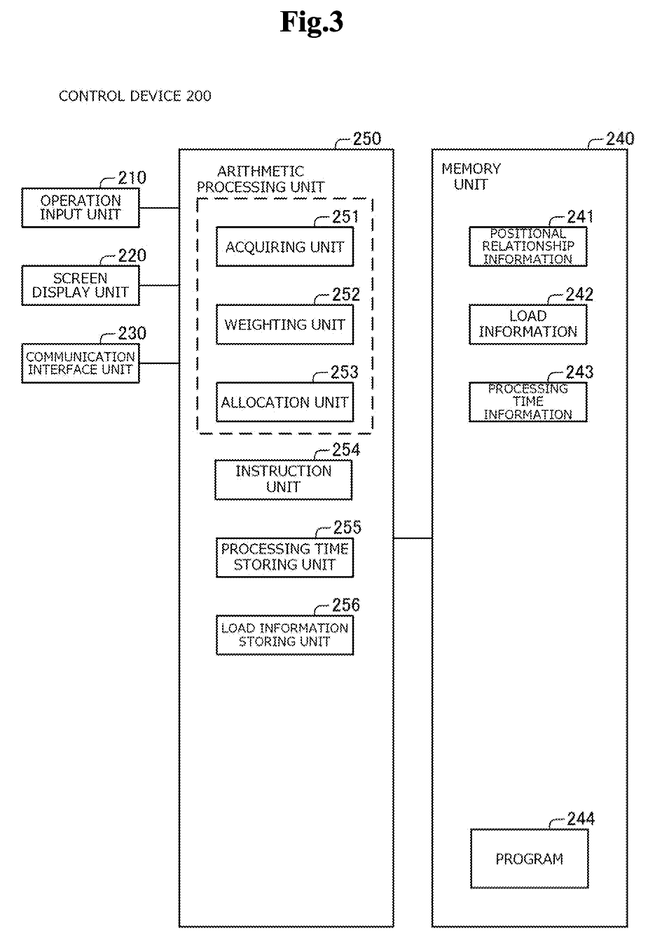

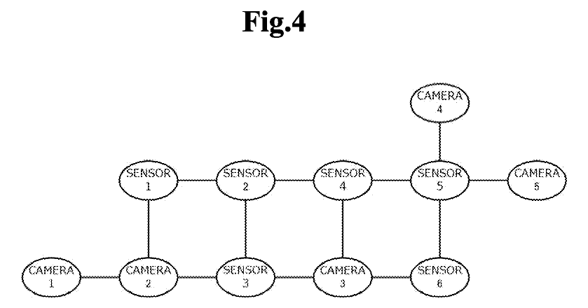

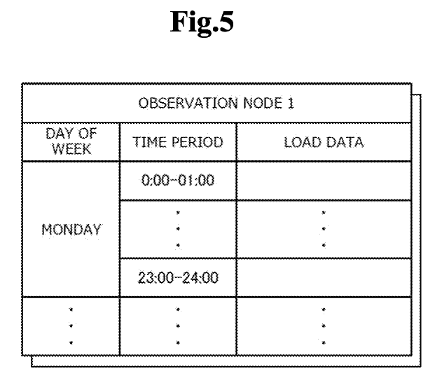

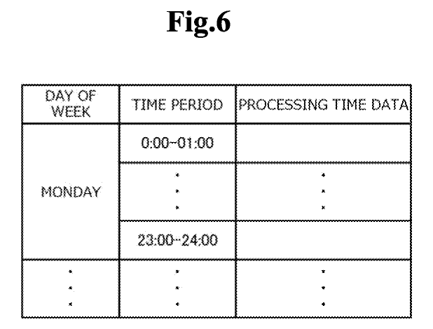

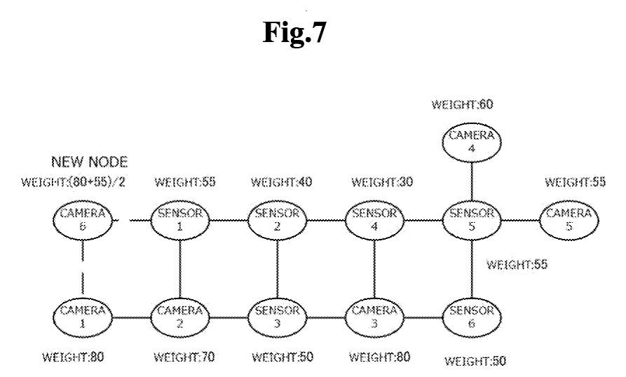

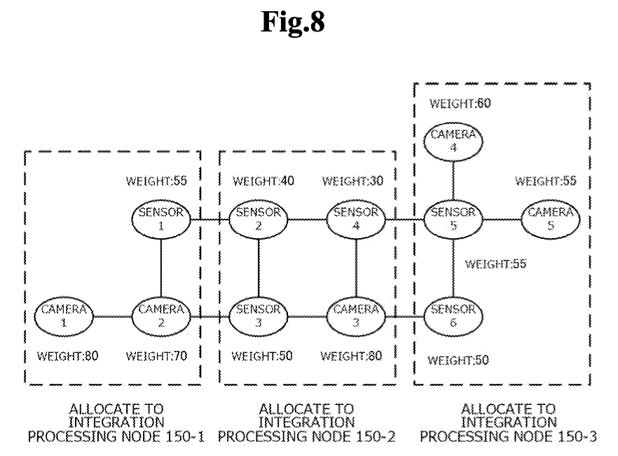

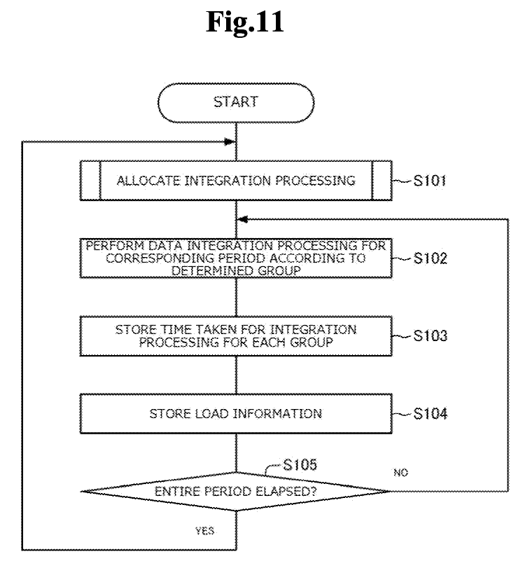

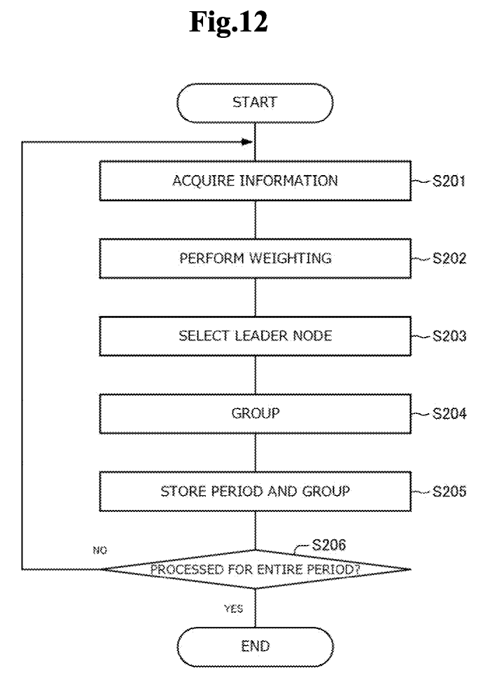

An example configuration of a data integration system 100 in the present disclosure will be described with reference to FIGS. 1 to 12. FIG. 1 illustrates an overview of integration processing. FIG. 2 illustrates an example configuration of the data integration system 100. FIG. 3 is a block diagram illustrating an example configuration of a control device 200. FIG. 4 illustrates an example of positional relationship information 241. FIG. 5 illustrates an example of load information 242. FIG. 6 illustrates an example of processing time information 243. FIG. 7 illustrates an example of weighting processing. FIGS. 8 to 10 illustrate an example of allocation processing. FIGS. 11 and 12 are flowcharts illustrating an example of operation during integration processing. In the present disclosure, the drawings may be associated with one or a plurality of example embodiments.

The present disclosure describes the data integration system 100 in which integration processing for integrating observation results by a plurality of observation nodes 110 included in the system is distributed among a plurality of integration processing nodes 150 . For example, the data integration system 100 acquires load information 242 indicating the load corresponding to each observation node 110 that observes an object. As an example, the data integration system 100 acquires the load information 242 that includes at least one of the number of observations of the object previously observed by each observation node 110 and the amount of movement indicating the amount by which the object has moved from the observation area, as information indicating the load during the integration processing. The data integration system 100 may acquire and store the load information 242 in advance by acquiring information from an analysis device 120 that analyzes the observation results of the observation nodes 110, or the like. The data integration system 100 also allocates the observation nodes 110 using the load information 242. For example, the data integration system 100 uses the load information 242 to apply a weight to each observation node 110. Furthermore, the data integration system 100 divides the observation nodes 110 into a plurality of groups using the weighting results and information indicating the positional relationship of the observation nodes 110. Thereafter, the data integration system 100 determines an integration processing node 150 responsible for each group, and allocates the observation nodes 110 subject to integration processing to each integration processing node 150. As an example, the data integration system 100 may perform allocation so that the load is distributed among the integration processing nodes 150 by, for example, distributing the weight values among the integration processing nodes 150.

Furthermore, the data integration system 100 is able to perform allocation for a predetermined number of days in advance. For example, the load information 242 contains information indicating the load during integration processing for each predetermined time period such as every hour, for one week. The load information 242 may include the above information for each weather type, such as rainy days and cloudy days. By using the load information 242, the data integration system 100 is able to perform, for example, hourly allocation for one week in advance. In this case, the data integration system 100 may acquire information indicating the weather forecast from an external device or the like and perform allocation using the acquired information. Furthermore, the data integration system 100 can instruct each integration processing node 150 to execute integration processing according to the results of allocation each time the allocated time arrives.

The observation node 110 may be at least one of a security camera, an infrared sensor, and any other sensor, or a combination thereof. The data integration system 100 may include a plurality of types of observation nodes 110. Furthermore, an object observed by the observation node 110 may be a person, a mobile device such as a drone or an automated guided vehicle, or any other object. For example, the observation node 110 observes an object with the purpose of reproducing the observation results in a digital space in an arbitrary digital twin system or the like. The observation node 110 may observe an object for purposes other than those mentioned above.

In the present disclosure, the integration processing node 150 included in the data integration system 100 performs, as integration processing, processing to recognize an object such as a person who moves across observation areas observed by the observation nodes 110 as a unique object. For example, for each of a pair of adjacent observation nodes 110, the integration processing node 150 acquires person information or the like that can be acquired by analyzing the observation result for a predetermined period of time, such as one hour. The integration processing node 150 then compares the acquired pieces of information to recognize a person or the like moving across the observation areas as a unique object. For example, FIG. 1 illustrates an example of integration processing in the case where observation results of a camera 1 and a camera 2, which are observation nodes 110, are to be integrated. Referring to FIG. 1, in the stage where the integration processing is not performed, the analysis device 120 performs separate recognition using the observation result of each observation node 110. Therefore, the data integration system 100 recognizes objects that move across the observation areas of the observation nodes 110 as separate objects such as a person A and a person B. On the other hand, when the integration processing node 150 performs integration using the time of passing through the observation area, it is possible to appropriately recognize an object such as a person moving across the observation areas. As a result, the data integration system 100 can appropriately recognize persons who move across the observation areas as the same person.

FIG. 2 illustrates an example configuration of the data integration system 100. Referring to FIG. 2, the data integration system 100 includes a plurality of observation nodes 110, the analysis device 120, an analysis data storage device 130, an integrated data storage device 140, the integration processing node 150, and a control device 200. As illustrated in FIG. 2, the observation node 110 and the analysis device 120 can be communicably connected to each other in a wired or wireless manner. The analysis device 120 and the analysis data storage device 130 can be communicably connected to each other in a wired or wireless manner. The analysis data storage device 130 and the integration processing node 150 can be communicably connected to each other in a wired or wireless manner. The integration processing node 150 and the integrated data storage device 140 can be communicably connected to each other in a wired or wireless manner. The control device 200 and the integration processing node 150 can be communicably connected to each other in a wired or wireless manner.

Note that FIG. 2 illustrates an example configuration of the data integration system 100. The configuration of the data integration system 100 is not limited to the example illustrated in FIG. 2. For example, respective components included in the data integration system 100 may be connected via a network or the like. The number of components included in the data integration system 100 may be other than that exemplified in FIG. 2. The data integration system 100 may have a configuration other than that exemplified in FIG. 2, such as a configuration in which the analysis device 120 and the analysis data storage device 130 are integrated.

The observation node 110 is a device that observes an object such as a person in a predetermined observation area. The observation node 110 may be at least one of a security camera, an infrared sensor, and any other sensor, or a combination thereof. For example, when the observation node 110 is a security camera, the observation node 110 can acquire time-series surveillance image data as an observation result.

The analysis device 120 is a device that analyzes the observation results from the observation nodes 110 and acquires person information and the like. The analysis device 120 can use the observation results of the observation node 110 to perform object detection processing to detect an object such as a person, and tracking processing to track the detected object within the observation area. In addition, by using the results of object detection processing and tracking processing, the analysis device 120 can measure the number of objects such as persons within the observation area as the number of observations, and measure the amount of movement that indicates the amount by which the object has moved from the observation area. The analysis device 120 may perform the above-described analysis processing using a model that has been trained in advance. Furthermore, when the observation node 110 is an infrared sensor or the like, the analysis device 120 may use information acquired from the observation node 110 to measure the number of observations, for example.

For example, the analysis device 120 performs the analysis processing for each observation node 110 using the observation result of each observation node 110. In other words, the analysis device 120 performs analysis processing individually using the observation result by each observation node 110. Furthermore, the analysis device 120 can store the results of the analysis processing in the analysis data storage device 130 or the like. The analysis data storage device 130 may be any storage device including a hard disk, memory, and the like.

The integration processing node 150 performs the above-described integration processing using information acquired from the analysis data storage device 130, and the like. In response to an instruction from the control device 200, the integration processing node 150 performs integration processing on the observation results of the observation nodes 110 allocated by the control device 200 . In other words, the integration processing node 150 may perform integration processing on each of the integration objects that can be identified by the instruction, such as a pair of adjacent observation nodes 110 among the observation nodes 110 included in the instruction from the control device 200. Furthermore, the integration processing node 150 can store the results of the integration processing in the integrated data storage device 140 or the like. The integrated data storage device 140 may be any storage device including a hard disk, memory, and the like.

After the integration processing is completed, the integration processing node 150 can notify the control device 200 that the integration processing has been completed. At this time, the integration processing node 150 may transmit information indicating the time taken for the integration processing, to the control device 200.

The control device 200 is an information processing apparatus that allocates observation nodes 110 to each of a plurality of integration processing nodes 150 using previously acquired load information 242 and the like. The control device 200 may perform allocation for each predetermined condition, such as for each predetermined time, each day of the week, each weather, or the like. The control device 200 is also able to instruct each integration processing node 150 to execute integration processing according to the allocation. FIG. 3 illustrates an example of the main components of the control device 200. Referring to FIG. 3, the control device 200 includes, as its main components, an operation input unit 210, a screen display unit 220, a communication interface unit 230, a memory unit 240, and an arithmetic processing unit 250.

FIG. 3 illustrates an example in which the functions of the control device 200 are realized using one information processing apparatus. However, the control device 200 may be realized using a plurality of information processing apparatus, such as at least a part of the functions as the control device 200 being realized on the cloud, for example. Furthermore, the control device 200 may not include some of the components exemplified above, such as not having the operation input unit 210 or the screen display unit 220, or may have components other than those exemplified above.

The operation input unit 210 is configured of operation input devices such as a keyboard and a mouse. The operation input unit 210 detects an operation by a user who operates the control device 200 and outputs the detected operation to the arithmetic processing unit 250.

The screen display unit 220 is configured of a screen display device such as a liquid crystal display or an organic electroluminescence (EL) display. The screen display unit 220 can display various types of information stored in the memory unit 240 on the screen in response to instructions from the arithmetic processing unit 250.

The communication interface unit 230 includes a data communication circuit and the like. The communication interface unit 230 performs data communication with an external device such as the integration processing node 150 connected via a communication line.

The memory unit 240 is a storage device such as a hard disk or a memory. The memory unit 240 stores processing information and programs 244 required for various types of processing by the arithmetic processing unit 250. The programs 244 are read into the arithmetic processing unit 250 and executed to realize various processing units. The programs 244 are read in advance from an external device or a storage medium via a data input/output function such as the communication interface unit 230 and is stored in the memory unit 240 . The main information stored in the memory unit 240 includes, for example, positional relationship information 241, the load information 242, processing time information 243, and the like.

The positional relationship information 241 includes information indicating the positional relationship of the observation nodes 110 such as security cameras and sensors. The positional relationship information 241 can be acquired in advance by accepting input using the operation input unit 210 or by receiving information from an external device via the communication interface unit 230, and can be stored in the memory unit 240.

FIG. 4 illustrates an example of the positional relationship information 241. Referring to FIG. 4, the positional relationship information 241 can have information indicating the positional relationship of the observation nodes 110 as graph information including information indicating positional relationships such as up/down, left/right, and height. For example, in the case of FIG. 4, the positional relationship information 241 indicates that the camera 1 and the camera 2 are adjacent to each other. The positional relationship information 241 may be other than that illustrated in FIG. 4.

The load information 242 includes information indicating the load corresponding to each observation node 110. For example, the load information 242 may include information indicating the load during integration processing for each predetermined condition. The load information 242 can be updated in response to the load information storing unit 256 storing information, for example. The load information 242 may be acquired in advance by accepting input using the operation input unit 210 or by receiving information from an external device via the communication interface unit 230, and may be stored in the memory unit 240.

FIG. 5 illustrates an example of the load information 242. Referring to FIG. 5, the load information 242 includes load data that is information indicating the load during integration processing for each observation node 110, for each condition such as a time period or day of the week. For example, in the the case of FIG. 5, the load information 242 includes load data for each hour for each day of the week. Here, the information indicating the load during the integration processing may include at least one of the number of observations of the object previously observed at the associated observation node 110 and the amount of movement indicating the amount by which the object has moved from the observation area. The number of observations or the amount of movement may include a plurality of past values, or may include a statistical value such as a total or an average. The information indicating the load during the integration processing may include information other than the aforementioned examples.

The load information 242 may include information other than those illustrated above. For example, the load information 242 may include the aforementioned various types of information for each weather type, such as rainy, sunny, and cloudy. The load information 242 may include the aforementioned various types of information for each predetermined event in the observation area or its surroundings. In this way, the load information 242 can include load data and the like for each of various conditions under which the load during the integration processing may fluctuate.

The processing time information 243 includes information indicating the time taken in the past integration processing. The processing time information 243 may include information indicating the aforementioned time for each of the conditions similar to the conditions included in the load information 242. The processing time information 243 can be updated by the processing time storing unit 255 storing information.

FIG. 6 illustrates an example of the processing time information 243. Referring to FIG. 6, the processing time information 243 includes processing time data indicating the time taken for the integration processing for each condition such as a time period or day of the week. For example, in the case of FIG. 6, the processing time information 243 includes processing time data for each hour for each day of the week. Here, the processing time data may include information indicating the time taken for the integration processing for each integration processing node 150. In other words, the processing time data can include processing time data for each of the groups in which processing is performed under the same conditions, such as the same time period. The processing time information 243 may include information other than that illustrated above.

The arithmetic processing unit 250 includes an arithmetic logic unit such as a CPU (Central Processing Unit) and its peripheral circuits. The arithmetic processing unit 250 reads and executes the program 244 from the memory unit 240, thereby causing the above hardware and the program 244 to cooperate to realize various processing units. The main processing units realized by the arithmetic processing unit 250 include, for example, an acquiring unit 251, a weighting unit 252, an allocation unit 253, an instruction unit 254, the processing time storing unit 255, and the load information storing unit 256.

Note that the arithmetic processing unit 250 may have a GPU (Graphics Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination thereof, instead of the above-described CPU.

The acquiring unit 251, the weighting unit 252, and the allocation unit 253 function as a planning unit that allocates the observation nodes 110. The planning unit can be activated at predetermined intervals, such as once a week, to make allocation for a predetermined number of days.

The acquiring unit 251 refers to the memory unit 240 and acquires information included in the positional relationship information 241, the load information 242, and the like.

The acquiring unit 251 is able to acquire at least one of weather forecast information, information indicating presence/absence of a predetermined event, and the like from an external device or the like. The acquiring unit 251 may acquire part of the information included in the load information 242 and the like using the acquired weather forecast information and the like. For example, the acquiring unit 251 is able to acquire, from the information included in the load information 242, load data that satisfies the conditions such as weather for each time period for which allocation is performed. The acquiring unit 251 also acquires the positional relationship information 241.

The weighting unit 252 uses the load information 242 acquired by the acquiring unit 251 to apply a weight to each observation node. For example, the weighting unit 252 is able to perform weighting using the corresponding load data for each condition such as day of the week or a time period for which allocation is performed. When performing weighting, the weighting unit 252 may use the positional relationship information 241 in addition to the above information.

For example, the weighting unit 252 performs weighting such that the greater the number of observations, the greater the weight. The weighting unit 252 also performs weighting such that the greater the amount of movement, the greater the weight. As an example, the weighting unit 252 may perform weighting while giving more importance to the amount of movement than the number of observations. For example, the weighting unit 252 performs weighting using the number of observations and the amount of movement included in the load information 242 as described above. Note that a specific calculation formula used by the weighting unit 252 to calculate the weight may be set arbitrarily.

When a new observation node 110 is added or the like, there may be a case where the load information 242 does not contain information corresponding to the added observation node 110. In such a case, the weighting unit 252 may calculate the weight of the newly added observation node 110 using the weight of the observation node 110 adjacent to the newly added observation node 110. For example, the weighting unit 252 refers to the positional relationship information 241 to identify the observation nodes 110 adjacent to the newly added observation node 110. Then, the weighting unit 252 is able to calculate the weight of the newly added observation node 110 by calculating the average value of the weights of the identified observation nodes 110. FIG. 7 illustrates an example of weighting by the weighting unit 252 when a new observation node 110 is added. Referring to FIG. 7, the weighting unit 252 refers to the positional relationship information 241 to identify the camera 1 and a sensor 1 as the observation nodes 110 adjacent to a camera 6 that is a newly added observation node 110. Then, the weighting unit 252 calculates the average of the weight "80" of the identified camera 1 and the weight "55" of the identified sensor 1 to thereby calculate the weight of the camera 6 that is the newly added observation node 110 to be "67.5".

The allocation unit 253 uses the weighting result from the weighting unit 252 to allocate the observation nodes 110 to each of a plurality of the integration processing nodes 150 for each condition such as day of the week or a time period. The allocation unit 253 may perform graph partitioning to allocate the observation nodes 110 to each of the plurality of integration processing nodes 150 using any algorithm. The weighting unit 252 performs weighting using the load information 242 as described above. Therefore, it can be said that the allocation unit 253 allocates the observation nodes 110 using the load information 242.

For example, the allocation unit 253 uses the weighting results and the positional relationship information 241 to divide the observation nodes 110 into groups according to the number of the integration processing nodes. As an example, the allocation unit 253 uses the weighting result to select a predetermined number of observation nodes 110 as leader nodes. The allocation unit 253 may select, as leader nodes, a number of observation nodes 110 equal to the number of integration processing nodes 150 included in the system, in order from the observation node 110 with the largest weight. At this time, it is desirable that the allocation unit 253 selects a leader node so that a predetermined condition is met, such as presence of an adjacent observation node 110 that is not a leader node, so that subsequent grouping is possible. Also, the allocation unit 253 allocates the observation nodes 110 included in the system to each selected observation node 110 that is a leader node by, for example, grouping adjacent observation nodes 110 starting from the selected observation node 110 that is a leader node. At this time, it is desirable that the allocation unit 253 performs the allocation so that the total weight values in the respective groups are somewhat equal. For example, by using the method described above, the allocation unit 253 divides the observation nodes 110 included in the system into a plurality of groups, each group consisting of adjacent observation nodes 110. Thereafter, the allocation unit 253 is able to allocate the observation nodes 110 to each integration processing node 150 by determining which integration processing node 150 will be in charge of each group. The allocation unit 253 may be configured to reselect a leader node when it is determined that an imbalance has occurred between groups due to the allocation described above.

FIG. 8 illustrates an example of allocation by the allocation unit 253 when the number of integration processing nodes 150 is three. Referring to FIG. 8, the allocation unit 253 selects three observation nodes 110 as leader nodes in descending order of weight so that grouping is possible. For example, in the case of FIG. 8, three observation nodes 110, that is, the camera 1, the camera 3, and the camera 4, are selected as leader nodes. Thereafter, the allocation unit 253 groups the nodes starting from the selected three leader nodes. As a result, the allocation unit 253 is able to divide the observation nodes 110 into three groups, as illustrated in FIG. 8. Furthermore, the allocation unit 253 determines the integration processing node 150 responsible for each group, so that it is possible to allocate the observation nodes 110 to each integration processing node 150.

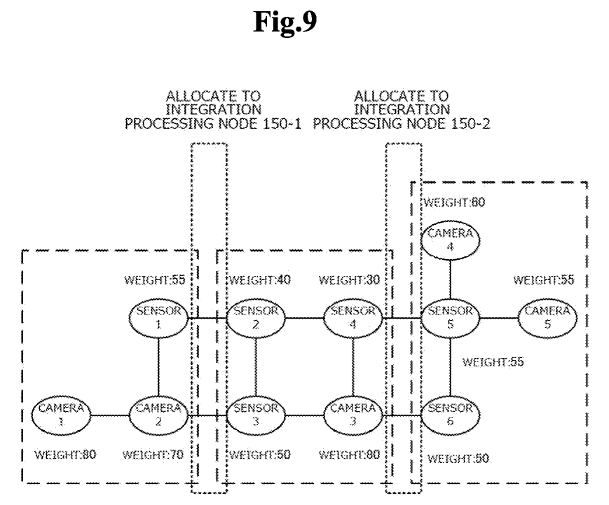

The allocation unit 253 is also able to allocate integration processing between groups to each integration processing node 150. The allocation unit 253 may allocate integration processing between groups to each integration processing node 150 using any method. For example, as illustrated in FIG. 9, the allocation unit 253 is able to allocate integration processing to the same integration processing node 150 for groups that are close to each other in the positional relationship information 241 or the like. For example, in the case of FIG. 9, integration processing between the left group and the center group is allocated to an integration processing node 150-1, and integration processing between the center group and the right group is allocated to an integration processing node 150-2. The allocation unit 253 may be configured to allocate more finely using weights or the like. For example, the allocation unit 253 may perform allocation using weights or the like so that the loads during integration processing on the respective integration processing nodes 150 become as equal as possible. As an example, in the case of FIG. 9, the allocation unit 253 may allocate integration processing between the sensor 1 and the sensor 2, integration processing between the camera 2 and a sensor 3, and the like, to be performed by different integration processing nodes 150.

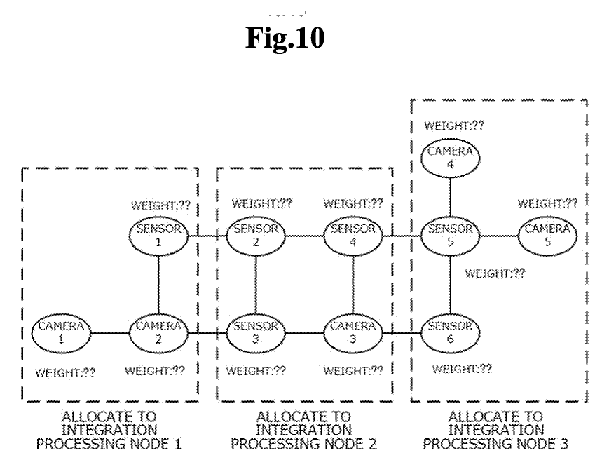

When the load information 242 contains insufficient information in the initial state or the like, it may be difficult to properly calculate the weight of each observation node 110. When it is difficult for the weighting unit 252 to calculate appropriate weights as described above, the allocation unit 253 may use the positional relationship information 241 to divide respective observation nodes 110 into a plurality of groups so that adjacent observation nodes 110 and the number of nodes become equal in the respective groups. FIG. 10 illustrates an example of allocation by the allocation unit 253 when the weights cannot be calculated. For example, in the case of FIG. 10, the allocation unit 253 performs allocation so that the number of observation nodes 110 in each group becomes three or four. Even in such a case, the allocation unit 253 may perform allocation using weights when it determines that the information included in the load information 242 satisfies the conditions and that appropriate weights can be calculated.

The allocation unit 253 may also perform the above-described allocation in consideration of the processing time information 243. For example, for an integration processing node 150 whose processing time data in the processing time information 243 exceeds a predetermined value, the allocation unit 253 may reduce the number of observation nodes 110 included in the group or adjust the grouping so that the total weight value becomes smaller. As an example, the allocation unit 253 may be configured to adjust the observation nodes 110 allocated to each group using the processing time information 243 after performing allocation using weights in the above-described manner.

The planning unit can be configured of the acquiring unit 251, the weighting unit 252, the allocation unit 253, and the like, as explained above. The processing by the planning unit and the processing by the instruction unit 254 and subsequent units do not necessarily have to be performed consecutively. For example, the allocation unit 253 constituting the planning unit may perform allocation for a predetermined number of days, such as one week, and then store information indicating the results of the allocation in the memory unit 240 or the like.

The instruction unit 254 uses the results of allocation by the allocation unit 253 to instruct each integration processing node 150 to perform integration processing. For example, the instruction unit 254 may transmit, to the integration processing node 150, an instruction including information about the observation nodes 110 or groups subject to integration processing. For example, the instruction unit 254 is able to refer to a clock function or the like to instruct each integration processing node 150 to execute integration processing each time a pre-allocated time arrives.

After completion of the integration processing by the integration processing node 150, the processing time storing unit 255 stores information indicating the time taken for the integration processing in the memory unit 240 as the processing time information 243. The time taken for the integration processing may be measured on the integration processing node 150 side or on the control device 200 side.

The load information storing unit 256 acquires information indicating the load corresponding to each observation node 110 during the time period in which the integration processing is performed, such as the number of observations and the amount of movement. For example, the load information storing unit 256 may acquire the aforementioned information via the integration processing node 150. Furthermore, the load information storing unit 256 is able to store the acquired information in the memory unit 240 as the load information 242.

The above is an example configuration of the control device 200. Next, an example of operation during the integration processing will be described with reference to FIGS. 11 and 12. First, an example of the overall operation during the integration processing will be described with reference to FIG. 11.

FIG. 11 is a flowchart illustrating an example of operation during the integration processing. Referring to FIG. 11, the planning unit that is configured of the acquiring unit 251, the weighting unit 252, and the allocation unit 253 allocates integration processing (step S101).

The instruction unit 254 uses the results of allocation by the allocation unit 253 to instruct each integration processing node 150 to perform integration processing. For example, the instruction unit 254 refers to the clock function or the like and, when the pre-allocated time arrives, instructs each integration processing node 150 to execute the integration processing. As a result, the integration processing node 150 performs integration processing on the instructed integration targets (step S102).

After completion of the integration processing by the integration processing node 150, the processing time storing unit 255 stores information indicating the time taken for the integration processing in the memory unit 240 as the processing time information 243 (step S103). The processing time storing unit 255 may store information for each integration processing node 150 or for each group.

The load information storing unit 256 acquires information indicating the load corresponding to each observation node 110 in the time period in which the integration process is performed, such as the number of observations and the amount of movement. For example, the load information storing unit 256 may acquire the aforementioned information via the integration processing node 150. Furthermore, the load information storing unit 256 is able to store the acquired information in the memory unit 240 as the load information 242 (step S104).

When the entire period for which allocation is made has not elapsed (step S105, NO), the instruction unit 254 refers to the clock function or the like, and when the next time for which allocation is made arrives, instructs each integration processing node 150 to execute integration processing. Thereby, the processing returns to step S102.

On the other hand, when the entire period for which allocation is made has elapsed (step S105, YES), the processing returns to step S101, and the planning unit performs the processing of step S101.

The above is an example of operation during the integration processing. In the processing illustrated in FIG. 11, the processing of step S101 is not necessarily performed consecutively with the processing of step S102 and subsequent steps. Next, the processing of step S101 will be described in more detail with reference to FIG. 12.

FIG. 12 illustrates a more detailed example of processing of step S101. Referring to FIG. 12, the acquiring unit 251 refers to the memory unit 240 to acquire information included in the positional relationship information 241, the load information 242, and the like (step S201). The acquiring unit 251 may acquire weather forecast information and the like, and use the acquired weather forecast information and the like to acquire part of the information included in the load information 242 and the like.

The weighting unit 252 applies a weight to each observation node using the load information 242 acquired by the acquiring unit 251 (step S202). For example, the weighting unit 252 is able to apply a weight using the corresponding load data for the time period for which allocation is made.

The allocation unit 253 uses the results of weighting by the weighting unit 252 to allocate the observation nodes 110 to each of a plurality of the integration processing nodes 150. For example, the allocation unit 253 uses the results of weighting to select a predetermined number of observation nodes 110 as leader nodes (step S203). The allocation unit 253 also allocates the observation nodes 110 included in the system to each of the selected observation nodes 110 that are leader nodes by, for example, grouping adjacent observation nodes 110 starting from the selected observation node 110 that is a leader node (step S204). Thereafter, the allocation unit 253 is able to store the allocation result in the memory unit 240 or the like (step S205).

When allocation has not been completed for all periods for which allocation is to be made (NO in step S206), the control device 200 returns to the processing of step S201 and continues allocation. On the other hand, when allocation has been completed for all periods for which allocation is to be made (YES in step S206), the control device 200 ends allocation of integration processing of step S101.

The above is a more detailed example of processing of step S101.

As described above, the control device 200 includes the acquiring unit 251, the weighting unit 252, and the allocation unit 253. With this configuration, the allocation unit 253 is able to allocate the observation nodes 110 to each of a plurality of integration processing nodes 150 using the results of weighting by the weighting unit 252 using the load information 242 acquired by the acquiring unit 251, and the like. As a result, it is possible to prevent the load from being placed unevenly on a specific integration processing node 150. This allows the control device 200 to achieve appropriate distribution when performing integration processing distributed among a plurality of integration processing nodes 150.

When the control device 200 performs appropriate distribution, each integration processing node 150 can perform integration processing on the appropriately distributed observation nodes 110 as integration targets. As a result, each integration processing node 150 is able to improve performance during integration processing. In other words, the use of the method described in the present disclosure can contribute to improvements of the integration processing performance of the integration processing node 150.

The allocation unit 253 is also able to perform allocation for each condition using load data for each condition, such as day of the week or a time period. As a result, the allocation unit 253 is able to perform more appropriate allocations. This allows the control device 200 to achieve more appropriate distribution when performing integration processing distributed among a plurality of integration processing nodes 150.

### Second Example Embodiment

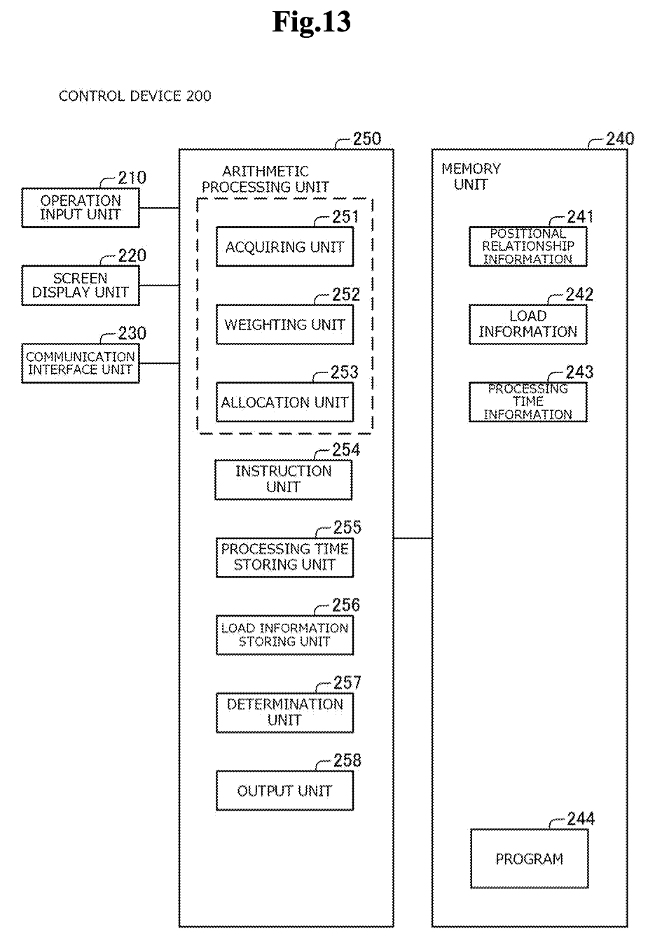

Next, a modification of the control device 200 described in the first example embodiment will be described with reference to FIG. 13. In the first example embodiment , an example configuration of the control device 200 has been described with reference to FIG. 3. However, the configuration of the control device 200 is not limited to the case illustrated in FIG. 3.

For example, FIG. 13 illustrates another example configuration of the control device 200. Referring to FIG. 13, the arithmetic processing unit 250 of the control device 200 is able to include at least one of a determination unit 257 and an output unit 258 in addition to the configuration illustrated in FIG. 3, by reading and executing the program 244.

The determination unit 257 uses the most recent information acquired before the instruction by the instruction unit 254, such as information indicating the load stored in the load information storing unit 256 and weather forecast information, to check whether or not there is a difference between the conditions at the time of previous allocation by the planning unit and the conditions when the instruction is actually given. When the determination unit 257 determines that there is a difference, the determination unit 257 instructs the planning unit configured of the acquiring unit 251, the weighting unit 252, and the allocation unit 253 to perform reallocation using the most recent information.

For example, when the determination unit 257 determines that there is a difference between the climate when the planning unit such as the allocation unit 253 performed allocation in advance and the actual climate, it instructs the planning unit to perform reallocation. Furthermore, when the determination unit 257 determines, based on the information indicating the load stored in the load information storing unit 256, that there is an observation node 110 whose load is greater or less than a predetermined value compared with the load when the planning unit performed allocation in advance, the determination unit 257 instructs the planning unit to perform reallocation. In this way, the determination unit 257 checks the actual situation to determine whether or not to perform reallocation. Note that, when the determination unit 257 determines that reallocation is necessary, the planning unit may perform reallocation, and then the instruction unit 254 may issue an instruction. Furthermore, the determination unit 257 may determine whether or not there is a difference using any method. For example, the determination unit 257 may make the aforementioned determination using an arbitrarily set threshold.

In this way, the control device 200 is able to include the determination unit 257. With this configuration, the determination unit 257 is able to check whether or not there is a difference between the condition when the planning unit previously performed allocation and the condition when an instruction is actually given, and to instruct reallocation if necessary. As a result, allocation that is more suitable for actual condition can be made when necessary. This allows the control device 200 to achieve more appropriate distribution when performing integration processing distributed among a plurality of integration processing nodes 150.

As described above, the control device 200 is also able to include the output unit 258. The output unit 258 outputs information such as those exemplified in FIGS. 8 and 9. The output unit 258 may display information on the screen display unit 220 or transmit information to an external device via the communication interface unit 230.

For example, the output unit 258 is able to output information such as that illustrated in FIGS. 8 and 9, which shows the results of allocation made in advance by the planning unit, and the groups and observation nodes 110 that each integration processing node 150 is actually responsible for. By outputting such information, a user checking the output can easily check whether or not distribution has been performed appropriately.

### Third Example Embodiment

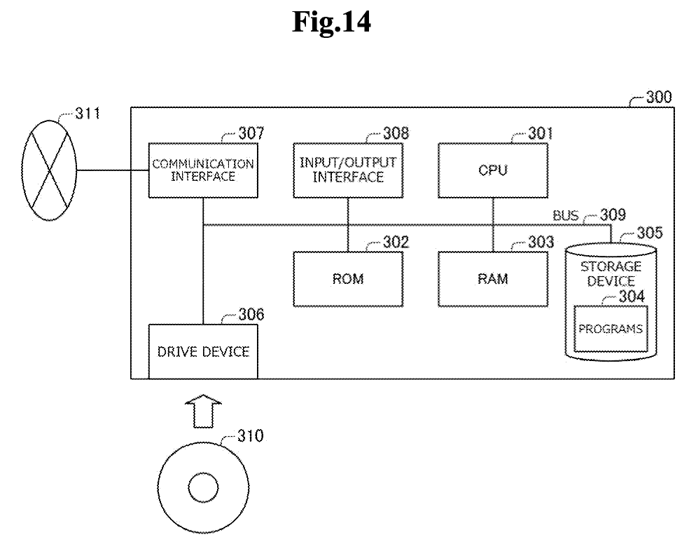

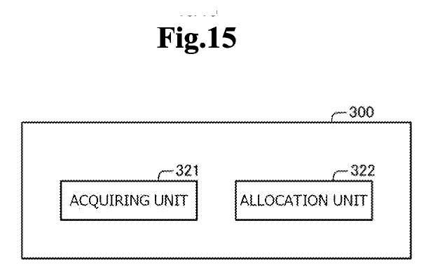

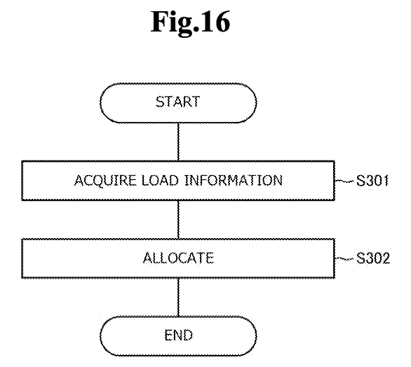

Next, an information processing apparatus 300 that is another modification of the control device 200 will be described with reference to FIGS. 14 to 16. FIG. 14 is a diagram illustrating an example of the hardware configuration of the information processing apparatus 300. FIG. 15 is a block diagram illustrating an example configuration of the information processing apparatus 300. FIG. 16 is a flowchart illustrating an example of operation of the information processing apparatus 300.

The information processing apparatus 300 is an apparatus that allocates observation nodes that perform observations subject to integration processing to a plurality of integration processing nodes that perform integration processing to integrate the observation results by the observation nodes. FIG. 14 illustrates an example of the hardware configuration of the information processing apparatus 300. Referring to FIG. 14, the information processing apparatus 300 has the following hardware configuration, for example:
a CPU (Central Processing Unit) 301 (arithmetic unit);
a ROM (Read Only Memory) 302 (memory unit);
a RAM (Random Access Memory) 303 (memory unit);
programs 304 loaded into the RAM 303;
a storage device 305 that stores the programs 304;
a drive device 306 that performs reading from and writing into a storage medium 310 external to the information processing apparatus 300;
a communication interface 307 connected to a communication network 311 external to the information processing apparatus 300;
an input/output interface 308 that performs input/output of data; and
a bus 309 connecting the components.

Furthermore, the information processing apparatus 300 is able to realize the functions of the acquiring unit 321 and the allocation unit 322 illustrated in FIG. 15 by the CPU 301 acquiring and executing the programs 304. The programs 304 are stored in advance in the storage device 305 or the ROM 302, for example, and are loaded into the RAM 303 or the like by the CPU 301 for execution as needed. The programs 304 may be supplied to the CPU 301 via the communication network 311, or may be stored in advance on the storage medium 310, and the drive device 306 may read out the programs and supply them to the CPU 301.

FIG. 14 illustrates an example of the hardware configuration of the information processing apparatus 300. The hardware configuration of the information processing apparatus 300 is not limited to the above-described case. For example, the information processing apparatus 300 may be configured with only part of the above-described configuration, such as excluding the drive device 306. Furthermore, the CPU 301 may be the GPU exemplified in the first example embodiment.

The acquiring unit 321 acquires load information indicating the load corresponding to each observation node that observes an object. For example, the acquiring unit 321 may acquire, for each observation node, load information including information indicating the load during integration processing for each predetermined condition.

The allocation unit 322 uses the load information acquired by the acquiring unit 321 to allocate the observation nodes that perform observations subject to integration processing to a plurality of integration processing nodes that perform integration processing to integrate the observation results by the observation nodes. For example, the allocation unit 322 may perform allocation for each predetermined condition.

The above is an example configuration of the information processing apparatus 300. Next, an example of operation of the information processing apparatus 300 will be described with reference to FIG. 16.

FIG. 16 is a flowchart illustrating an example of operation of the information processing apparatus 300. Referring to FIG. 16, the acquiring unit 321 acquires load information indicating the load corresponding to each observation node that observes an object (step S301).

The allocation unit 322 uses the load information acquired by the acquiring unit 321 to allocate the observation nodes that perform observations subject to integration processing to a plurality of integration processing nodes that perform integration processing to integrate the observation results by the observation nodes (step S302).

As described above, the information processing apparatus 300 includes the acquiring unit 321 and the allocation unit 322 . With this configuration, the allocation unit 322 is able to allocate observation nodes to a plurality of integration processing nodes using the load information acquired by the acquiring unit 321. As a result, it is possible to prevent the load from being unevenly placed on a specific integration processing node. This allows the information processing apparatus 300 to achieve appropriate distribution when performing integration processing distributed among a plurality of integration processing nodes.

The information processing apparatus 300 described above can be realized by installing a predetermined program in an apparatus such as the information processing apparatus 300. Specifically, a program that is another aspect of the present disclosure is a program for realizing, on an apparatus such as the information processing apparatus 300, processing to acquire load information indicating the load corresponding to each observation node that observes an object, and with use of the acquired load information, allocate observation nodes that perform observations subject to integration processing to a plurality of integration processing nodes that perform integration processing to integrate observation results by the observation nodes.

Furthermore, an information processing method, executed by an apparatus such as the information processing apparatus 300 described above, is a method of, by the apparatus such as the information processing apparatus 300, acquiring load information indicating the load corresponding to each observation node that observes an object, and with use of the acquired load information, allocating the observation nodes that perform observations subject to integration processing to a plurality of integration processing nodes that perform integration processing to integrate observation results by the observation nodes.

Even a program, a computer-readable storage medium having a program stored thereon, or an information processing method, having the above-described configuration, can achieve the same functions and effects as the above-described information processing apparatus 300, and therefore can achieve the above-described object of the present disclosure.

### Supplementary Notes

The whole or part of the example embodiments disclosed above can be described as the following supplementary notes. An overview of the information processing apparatus and the like according to the present disclosure will be described below. However, the present disclosure is not limited to the following configuration.

### Supplementary Note 1

An information processing apparatus comprising:

an acquiring unit that acquires load information indicating a load corresponding to each of observation nodes that observes an object; and

an allocation unit that, with use of the acquired load information, allocates observation nodes that perform observations subject to integration processing to a plurality of integration processing nodes that perform integration processing to integrate observation results by the observation nodes.

### Supplementary Note 2

The information processing apparatus according to supplementary note 1, wherein

the load information includes, for each of the observation nodes, information indicating a load during the integration processing for each predetermined condition, and

the allocation unit allocates the observation nodes for the each predetermined condition.

### SUPPLEMENTARY NOTE 3

The information processing apparatus according to supplementary note 2, wherein

the load information includes, as the information indicating the load during the integration processing, at least one of a number of observations of the object observed previously and an amount of movement indicating an amount by which the object moved from an observation area.

### Supplementary Note 4

The information processing apparatus according to any one of supplementary notes 1 to 3, further comprising

a weighting unit that performs weighting on each of the observation nodes using the load information, wherein

the allocation unit allocates the observation nodes using a weighting result by the weighting unit.

### Supplementary Note 5

The information processing apparatus according to any one of supplementary notes 1 to 4, wherein

with use of positional relationship information indicating a positional relationship of the observation nodes, the allocation unit divides the observation nodes into groups according to a number of the integration processing nodes, and allocates the observation nodes by determining an integration processing node responsible for each of the groups.

### Supplementary Note 6

The information processing apparatus according to supplementary note 3, wherein

the load information includes information indicating at least one of the number of observations of the object and the amount of movement indicating the amount by which the object moved from the observation area, for at least one condition among day of a week, weather, and a time period.

### Supplementary Note 7

The information processing apparatus according to any one of supplementary notes 4 to 6, wherein

for an observation node in which weighting using the load information is not possible, the weighting unit performs weighting using a weighting result with respect to another observation node that is adjacent to the observation node.

### Supplementary Note 8

The information processing apparatus according to any one of supplementary notes 1 to 7, wherein

the allocation unit allocates the observation nodes using information indicating a time taken in past integration processing and the load information.

### Supplementary Note 8-1

The information processing apparatus according to any one of supplementary notes 1 to 8, further comprising

an instruction unit that instructs each of the integration processing nodes to perform integration processing according to an allocation result by the allocation unit.

### Supplementary Note 9

9. An information processing method comprising, by an information processing apparatus:

acquiring load information indicating a load corresponding to each of observation nodes that observes an object; and

with use of the acquired load information, allocating observation nodes that perform observations subject to integration processing to a plurality of integration processing nodes that perform integration processing to integrate observation results by the observation nodes.

### Supplementary Note 10

A program for causing an information processing apparatus to execute processing to:

acquire load information indicating a load corresponding to each of observation nodes that observes an object; and

with use of the acquired load information, allocate observation nodes that perform observations subject to integration processing to a plurality of integration processing nodes that perform integration processing to integrate observation results by the observation nodes.

### Supplementary Note 10-1

An integration system comprising:

an information processing apparatus including an acquiring unit that acquires load information indicating a load corresponding to each of observation nodes that observes an object, and an allocation unit that, with use of the acquired load information, allocates observation nodes that perform observations subject to integration processing to a plurality of integration processing nodes that perform integration processing to integrate observation results by the observation nodes; and

the plurality of integration processing nodes that perform integration processing to integrate observation results by the observation nodes allocated by the information processing apparatus.

Note that some or all of the configurations described in Supplementary Notes 2 to 8-1 that are dependent on the information processing apparatus described as Supplementary Note 1 may also be dependent in a similar dependent relationship on the information processing method described in Supplementary Note 9, the program described in Supplementary Note 10, the integrated system described in Supplementary Note 10-1, and the like. Furthermore, not limited to Supplementary Notes 9, 10, and 10-1, some or all of the configurations described as supplementary notes may also be dependent on various hardware, software, and various storage means for storage software, methods, programs, or systems within the scope of each of the above-mentioned example embodiments.

Furthermore, the programs described in the example embodiments and supplementary notes described above can be stored in and supplied to a computer using various types of non-transitory computer readable media. Non-transitory computer-readable media include various types of tangible storage media. Examples of non-transitory computer-readable media include magnetic storage media (e.g., flexible disks, magnetic tapes, hard disk drives), magneto-optical storage media (e.g., magneto-optical disks), CD-ROMs (Read Only Memory), CD-Rs, CD-R/Ws, and semiconductor memories (e.g., mask ROMs, PROMs (Programmable ROMs), EPROMs (Erasable PROMs), flash ROMs, and RAMs (Random Access Memory)). In addition, a program may be provided to a computer by various types of transitory computer-readable media. Examples of transitory computer-readable media include electrical signals, optical signals, and electromagnetic waves. A transitory computer-readable medium may provide a program to the computer via a wired communication channel, such as an electric wire and an optical fiber, or a wireless communication channel.

Although the present disclosure has been described above with reference to the above-described example embodiments, the present disclosure is not limited to the above-described example embodiments. The configurations and details of the present disclosure can be changed in a variety of ways that those skilled in the art can understand within the scope of the present disclosure. Each embodiment can be combined with other embodiments as appropriate.

### REFERENCE SIGNS LIST

100 data integration system

110 observation node

120 analysis device

130 analysis data storage device

140 integrated data storage device

150 integration processing node

200 control device

210 operation input unit

220 screen display unit

230 communication interface unit

240 memory unit

241 positional relationship information

242 load information

243 processing time information

244 program

250 arithmetic processing unit

251 acquiring unit

252 weighting unit

253 allocation unit

254 instruction unit

255 processing time storing unit

256 load information storing unit

257 determination unit

258 output unit

300 information processing apparatus

301 CPU

302 ROM

303 RAM

304 programs

305 storage device

306 drive device

307 communication interface

308 input/output interface

309 bus

310 storage medium

311 communication network

321 acquiring unit

322 allocation unit

1. An information processing apparatus comprising:
at least one memory configured to store instructions; and
at least one processor configured to execute the instructions to:
acquire load information indicating a load corresponding to each of observation nodes that observes an object; and
with use of the acquired load information, allocate observation nodes that perform observations subject to integration processing to a plurality of integration processing nodes that perform integration processing to integrate observation results by the observation nodes.

2. The information processing apparatus according to claim 1, wherein
the load information includes, for each of the observation nodes, information indicating a load during the integration processing for each predetermined condition, and
the at least one processor is configured to execute the instructions to allocate the observation nodes for the each predetermined condition.

3. The information processing apparatus according to claim 2, wherein
the load information includes, as the information indicating the load during the integration processing, at least one of a number of observations of the object observed previously and an amount of movement indicating an amount by which the object moved from an observation area.

4. The information processing apparatus according to claim 1, wherein the at least one processor is configured to execute the instructions to:
perform weighting on each of the observation nodes using the load information; and
allocate the observation nodes using a weighting result.

5. The information processing apparatus according to claim 1, wherein the at least one processor is configured to execute the instructions to,
with use of positional relationship information indicating a positional relationship of the observation nodes, divide the observation nodes into groups according to a number of the integration processing nodes, and allocate the observation nodes by determining an integration processing node responsible for each of the groups.

6. The information processing apparatus according to claim 3, wherein
the load information includes information indicating at least one of the number of observations of the object and the amount of movement indicating the amount by which the object moved from the observation area, for at least one condition among day of a week, weather, and a time period.

7. The information processing apparatus according to claim 4, wherein the at least one processor is configured to execute the instructions to,
for an observation node in which weighting using the load information is not possible, perform weighting using a weighting result with respect to another observation node that is adjacent to the observation node.

8. The information processing apparatus according to claim 1, wherein the at least one processor is configured to execute the instructions to
allocate the observation nodes using information indicating a time taken in past integration processing and the load information.

9. An information processing method comprising, by an information processing apparatus:
acquiring load information indicating a load corresponding to each of observation nodes that observes an object; and
with use of the acquired load information, allocating observation nodes that perform observations subject to integration processing to a plurality of integration processing nodes that perform integration processing to integrate observation results by the observation nodes.

10. A non-transitory computer-readable storage medium storing thereon a program comprising instructions for causing an information processing apparatus to execute processing to:
acquire load information indicating a load corresponding to each of observation nodes that observes an object; and
with use of the acquired load information, allocate observation nodes that perform observations subject to integration processing to a plurality of integration processing nodes that perform integration processing to integrate observation results by the observation nodes.
